(19) United States
(12) Patent Application Publication
(10) Pub. No.: US 2014/0304964 A1
(43) Pub. Date: Oct. 16, 2014

(54) PROBE HEIGHT FIXTURE PRODUCT PROFILE

(71) Applicant: Bio-Rad Laboratories, Inc., Hercules, CA (US)

(72) Inventor: Todd Yeck, Sausalito, CA (US)

(73) Assignee: Bio-Rad Laboratories, Inc., Hercules, CA (US)

(21) Appl. No.: 14/249,213

(22) Filed: Apr. 9, 2014

Related U.S. Application Data
(60) Provisional application No. 61/811,672, filed on Apr. 12, 2013.

(51) Int. Cl. G01D 18/00; G01B 5/02

(52) U.S. Cl. CPC G01D 18/00; G01B 5/02
USPC 29/407.1; 33/545

(57) ABSTRACT

Systems, methods, and apparatuses are provided for using a calibration fixture adapted for use with a measurement instrument having a sample probe needle. The calibration fixture can be used for calibrating a maximum depth the sample probe needle will travel to for optimal aspiration of samples within the wells of one or more of multiple different microplates. The calibration fixture can include multiple cavities to calibrate the sample probe needle height for each of multiple different microplates. Each cavity has a cavity height that corresponds with a known depth of the wells disposed within each different microplate.

### CROSS-REFERENCES TO RELATED APPLICATIONS

This application claims the benefit of Provisional Application No. 61/811,672, filed Apr. 12, 2013, entitled “Probe Height Fixture Product Profile,” the disclosure of which is hereby incorporated herein by reference.

### BACKGROUND OF THE INVENTION

A microplate (or microtiter plate) is a flat plate with multiple wells used as small tubes. The microplate has become a standard tool in analytical research and clinical diagnostic testing laboratories. Example microplates are depicted in prior art FIGS. 1A-1B. A microplate typically has 6, 24, 96, 384 or even 1536 sample wells arranged in a rectangular matrix. Each well of a microplate typically holds somewhere between tens of nanoliters to several milliliters of liquid. Generally, microplates are used in systems that measure biological activity of a sample such as a liquid or powder reagent. Today, there are microplates for just about every application in life science research involving filtration, separation, optical detection, storage, or reaction mixing. The set of wells in each microplate are adapted to hold the various reagents for use in one or more assays as is well known in the art.

Various problems exist in conventional measurement systems that use microplates. First, the desired microplate must be determined before the height of the sample probe needle used to aspirate the wells in the microplate can be set. Software can be provided to perform this task, but often manual readjustment is needed. Also various spacers can be used to fine tune the adjustment of probe height for a particular microplate. The spacers provide a small change in the depth of a well and are used to prevent the sample probe needle from coming into contact with the bottom of the well. This is an unreliable process because, using these techniques, it is possible to damage the sample probe needle or other instrument mechanisms and can also lead to inaccurate calibration.

In addition, the microplates can bend in a variety of ways resulting in inconsistent or inaccurate calibration. Inaccurate calibration can lead to drawing air into the system or restriction of sample uptake resulting in lost data or requiring additional maintenance. Further, in many conventional systems, only one probe height calibration value can be stored and changing the microplate type requires calibration to be repeated.

### BRIEF SUMMARY OF THE INVENTION

The embodiments described herein relate generally to systems for measuring biological activity of sample reagents. More particularly, the embodiments described herein relate to a system for automatically setting a maximum depth a sample probe needle can travel when used with multiple different microplates.

According to one embodiment, a system is provided that includes a calibration fixture for use with a measurement instrument having a sample probe needle. The calibration fixture can be used for calibrating a maximum depth the sample probe needle will travel to (referred to herein as the “sample probe needle height”) for optimal aspiration of samples within the wells of one or more of multiple different microplates. The calibration fixture includes multiple cavities disposed therein adapted to calibrate the sample probe needle height for each of multiple different microplates. Each cavity has a cavity height that corresponds with a known depth of the wells disposed within each different microplate.

According to another embodiment of the invention, a method is provided of using a calibration fixture adapted for use with a measurement instrument. The calibration fixture may have multiple cavities, each cavity associated with one of multiple different microplates and having a cavity height dimension corresponding to a known depth of a set of wells within one of the multiple different microplates. The cavity height dimension is different among the multiple cavities. The set of wells are adapted to contain various reagents for use in one or more assays. The method comprises calibrating a sample probe needle height for the measurement instrument. The calibrating comprises: (1) receiving, at a user input of the measurement instrument, a selection of a microplate name assigned to a first microplate of the multiple different microplates to be calibrated; (2) mapping the microplate name to a maximum depth the sample probe needle can travel into the set of wells for the first microplate; (3) assigning the sample probe needle height based on the maximum depth the sample probe needle can travel into the set of wells for the first microplate; and (4) repeating calibrating the sample probe needle height for each of the other of the multiple different microplates.

According to another embodiment of the invention, an article of manufacturing is provided. The article of manufacturing comprises a computer-readable storage medium having instructions stored thereon which when executed by a computer are configured to calibrate a sample probe needle height using a calibration fixture adapted for use with a measurement instrument. The calibration fixture having multiple cavities, each cavity associated with one of multiple different microplates and having a cavity height dimension corresponding to a known depth of a set of wells within one of the multiple different microplates. The cavity height dimension is different among the multiple cavities, and the set of wells are adapted to contain various reagents for use in one or more assays. The instructions comprise: (1) instructions to receive, at a user input of the measurement instrument, a selection of a microplate name assigned to a first microplate of the multiple different microplates to be calibrated; (2) instruction to map the microplate name to a maximum depth the sample probe needle can travel into the set of wells for the first microplate; (3) instructions to assign the sample probe needle height based on the maximum depth the sample probe can travel into the set of wells for the first microplate; and (4) instructions to repeat calibration of the sample probe needle height for each of the other of the multiple different microplates.

According to another embodiment of the invention, a calibration fixture is provided. The calibration fixture is formed in the shape of a microplate and adapted for use with the measurement instrument. The calibration fixture comprises a base and multiple cavities disposed within the base. Each cavity is associated with one of multiple different microplates and having a cavity height dimension corresponding to a known depth of a set of wells within one of the multiple different microplates. Each cavity is assigned to one of the multiple different microplates and the cavity height dimension is different among the multiple cavities. The set of wells are adapted to contain various reagents for use in one or more assays.

According to another embodiment of the invention, a method is provided. The method comprises forming a calibration fixture in the shape of a microplate. The calibration fixture comprises multiple cavities each associated with one of multiple different microplates and having a cavity height dimension corresponding to a known depth of a set of wells within one of the multiple different microplates. Each cavity is assigned to one of the multiple different microplates and the cavity height dimension is different among the multiple cavities. The set of wells are adapted to contain various reagents for use in one or more assays. The method further comprises empirically determining a maximum depth a sample probe needle of a measurement instrument can travel into the set of wells of the microplates for each of the multiple different microplates. The method further comprises determining a sample probe needle height based on the maximum depth, and storing the sample probe needle height in a computer-readable storage medium for later retrieval during a calibration operation by a user.

These and other embodiments along with many of their advantages and features are described in more detail in the description below and attached figures.

### BRIEF DESCRIPTION OF THE DRAWINGS

FIG. 1A depicts a graphical representation of a microplate according to the prior art.

FIG. 1B depicts a graphical representation of a microplate according to the prior art.

FIG. 2 depicts a graphical representation of a probe height calibration fixture according to one example embodiment.

FIG. 3 depicts alternate views of a probe height calibration fixture according to one example embodiment.

FIG. 4A depicts an example flow chart of a process of providing a probe height calibration system for use with a measurement instrument according to one embodiment.

FIG. 4B depicts an example flow chart of a process of calibrating a sample probe needle height using a calibration fixture according to one embodiment.

FIG. 5A depicts an example screen shot of a user interface used in a process for calibrating a probe height according to one embodiment.

FIG. 5B depicts an example screen shot of a user interface used in a process for calibrating a probe height according to one embodiment.

FIG. 5C depicts an example screen shot of a user interface used in a process for calibrating a probe height according to one embodiment.

FIG. 6 depicts an example block diagram of a data processing system upon which the disclosed embodiments may be implemented.

### DETAILED DESCRIPTION OF THE INVENTION

Throughout this description for the purposes of explanation, numerous specific details are set forth in order to provide a thorough understanding of the techniques described herein. It will be apparent, however, to one skilled in the art that the present invention may be practiced without some of these specific details. In other instances, well-known structures and devices are shown in block diagram form to avoid obscuring the underlying principles of the described embodiments.

The embodiments described herein relate generally to systems for measuring biological activity of sample reagents. More particularly, the embodiments described herein relate to a system for automatically testing and setting a maximum depth a sample probe needle can travel when used with multiple different microplates.

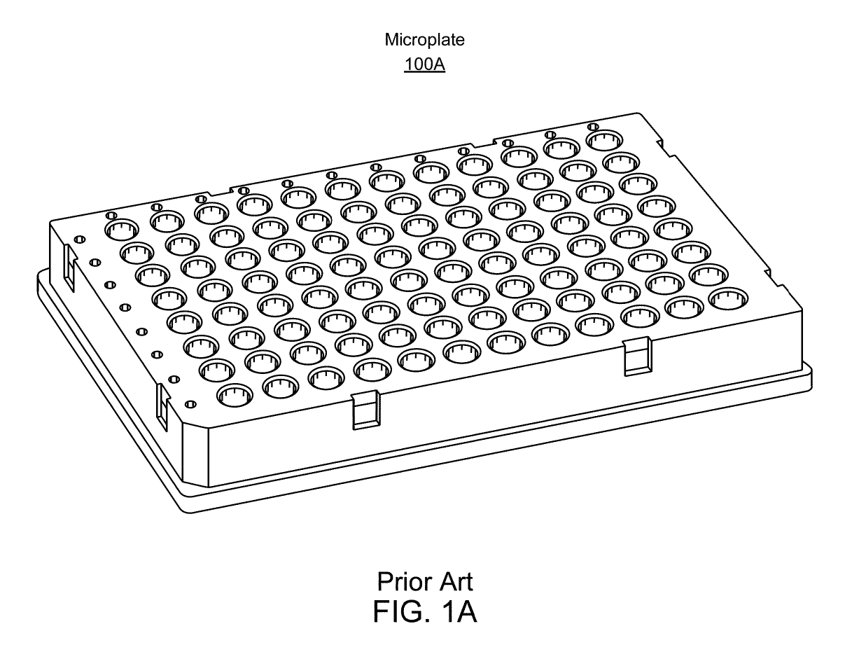

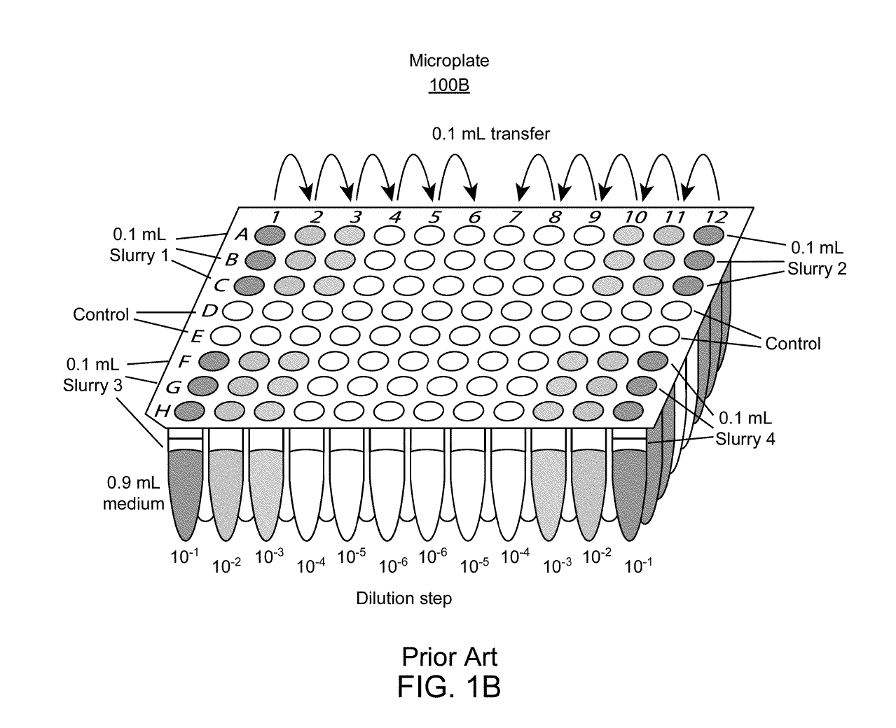

FIGS. 1A and 1B depict two different types of 96-well microplates. The dimensions of the plates and the spacing of the wells conform to a standard specification for microplates allowing them to be used in a variety of different instruments. The standard does not, however, include a specified value for the depth of each well. The depth of each well is the same within an individual plate and is consistent in all plates of the same type, but this depth varies between different types of plates. The sample probe needle should be positioned near the bottom of the wells without touching in order to aspirate fluid effectively from each type of plate. Since the depth of the wells is not the same in all types of plates, the position of the probe needle, referred to herein as the “probe height,” will be different for each type of microplate. As used herein the probe height is defined as the height above the platform adapted to hold the microplates.

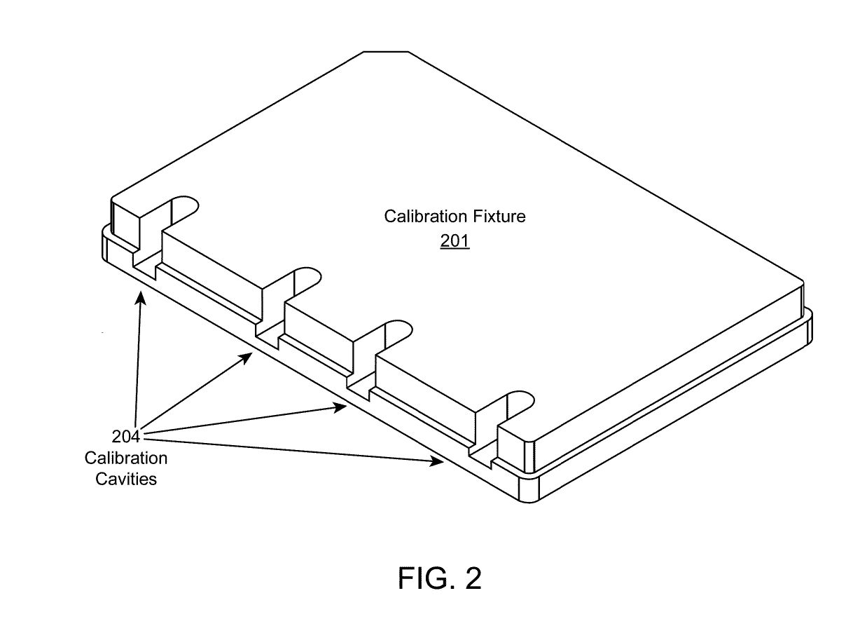

FIG. 2 depicts a graphical representation of a probe height calibration fixture according to one example embodiment. Calibration fixture 201 includes a set of multiple cavities 204. The cavities can be a well or a notch in the calibration fixture. The cavities 204 each correspond to one slot in the calibration fixture 201. Each slot is configured to represent one of multiple different microplates and each cavity 204 is set at a particular height to facilitate calibration of the depth a sample probe needle should travel into each of the wells of the multiple microplates. This sample probe needle height in each slot is based on a known depth of the wells in each microplate that the slot is representing. The cavity height is determined for each of the multiple cavities in the calibration fixture based on the depth of each of the corresponding sets of wells in the multiple different microplates. The techniques described herein are adapted to automatically set the cavity height determined for each of the multiple cavities 204.

A programmable module (not shown) can be used in a system with the calibration fixture to determine the maximum depth a sample probe needle can travel into each of the wells based on the corresponding cavity height. The module can then assign a calibration position for each of the multiple microplates based on the maximum depth and this calibration position can then be stored in memory for each of the microplates for use during system operation. For example, in embodiments of the invention, the module may calibrate multiple microplates (e.g. up to 4, up to 10, etc,) in a single operation, store the values, and retrieve any of the values at a later time without performing additional calibration. In at least certain embodiments, the maximum depth the sample probe needle can travel into each set of wells can be determined such that the sample probe needle comes to rest near the bottom of the well reservoirs during operation to enable the reagents to be aspirated until the reservoir is almost empty without damaging the probe or the microplates. The same technique can be used for dispensing reagents into the wells of the microplates using the sample probe needle. The calibration fixture includes multiple slots, each of which corresponds to one of the multiple different microplates.

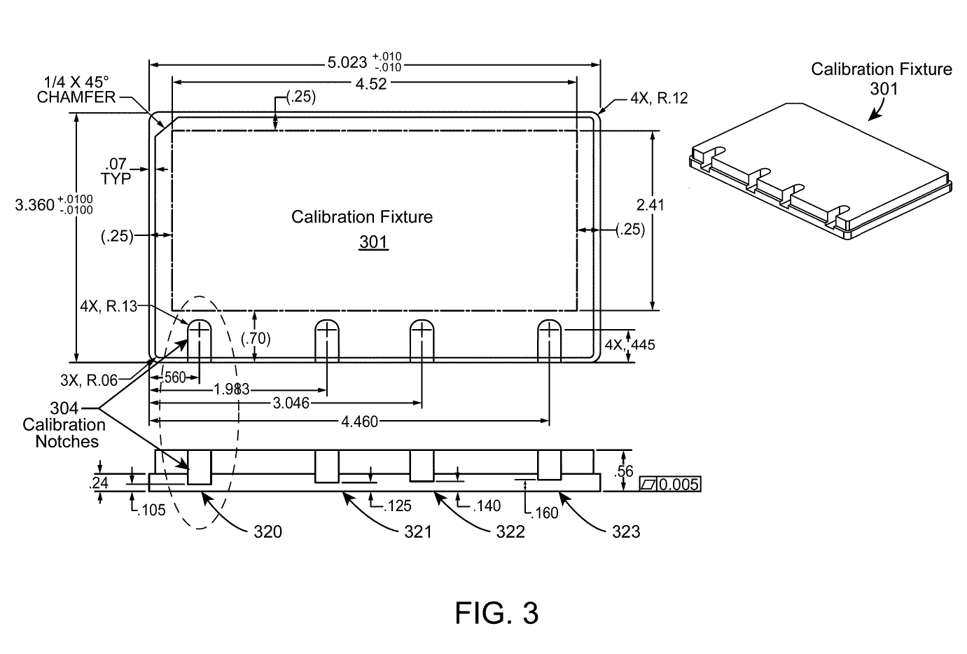

FIG. 3 depicts alternate views of a probe height calibration fixture according to one example embodiment. In the illustrated embodiment, four different microplates can be supported corresponding to the four calibration cavities 304. But additional or fewer microplates can be supported in alternative embodiments by providing additional or fewer cavities 304. Each of the calibration cavities 304 of the calibration fixture 301 can be set to a different height that corresponds to the well depths in the multiple different microplates. For instance, as shown in the figure, the height of notch 320 is set to 0.105 cm, the height of notch 321 is set to 0.125 cm, the height of notch 322 is set to 0.140 cm, the height of notch 323 is set to 0.160 cm. These heights are provided for illustration and are not intended to be limiting as any number of different heights can be chosen based on the microplates that are to be used.

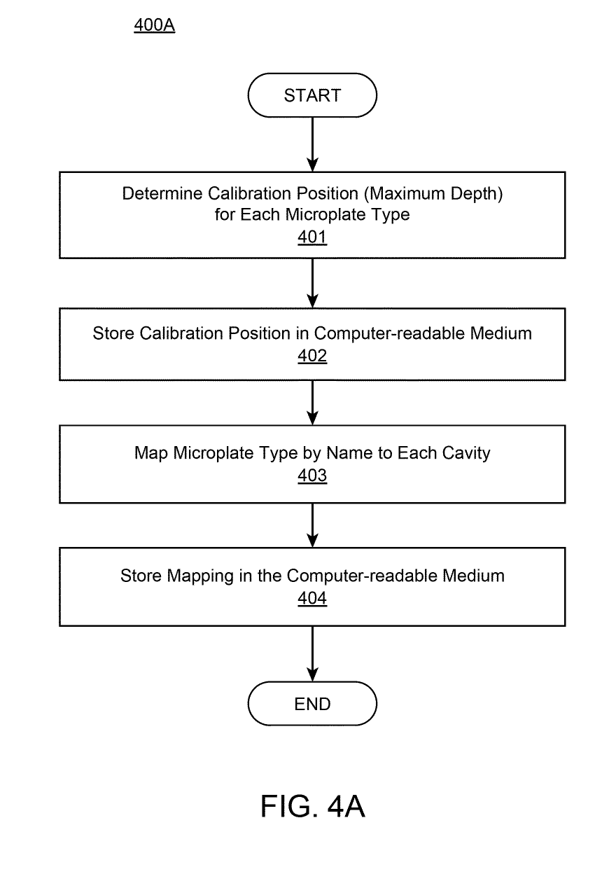

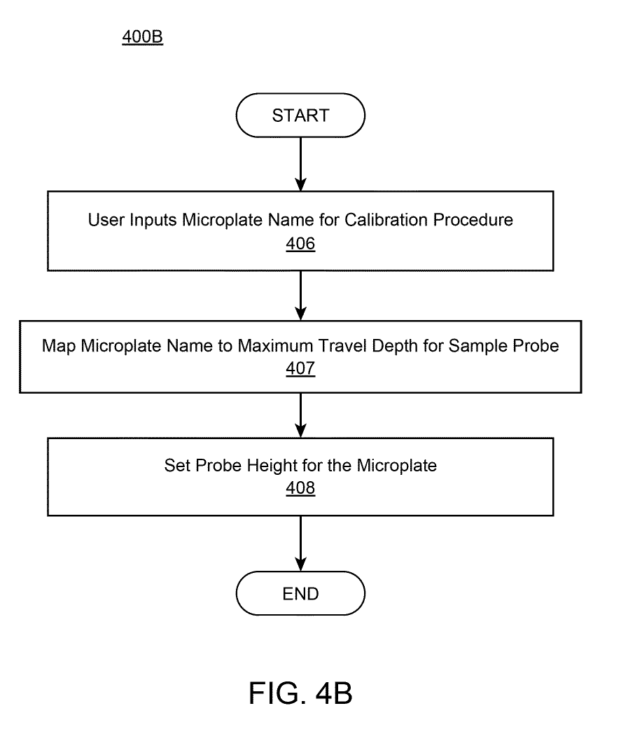

FIG. 4A depicts an example flow chart of a process of providing a probe height calibration system for use with a measurement instrument according to one embodiment. Process 400 can be performed using a calibration fixture in the shape of a microplate. The calibration fixture includes multiple cavities each associated with one of multiple different microplates and having a cavity height dimension corresponding to a known depth of a set of wells within one of the multiple different microplates. Each cavity can be assigned to one of the multiple different microplates and the cavity height dimension can be different among the multiple cavities. For example, a first cavity may correspond to a first microplate such as a Flat Bottom Plate, a second cavity may correspond to a second microplate such as a PCR Plate, a third cavity may correspond to a third microplate such as a Filter Plate, and a fourth cavity may correspond to a fourth microplate such as an Auxiliary Flat Plate. These microplates are provided for illustration and are not intended to be limiting to any particular microplate types as any microplate types can be used. The set of wells in the microplates are adapted to contain various reagents for use in one or more assays.

In the illustrated embodiment, process 400 begins at operation 401 by determining a maximum depth a sample probe needle of the measurement instrument can travel into the set of wells of the microplates for each of the multiple different microplates. In one embodiment, the maximum depth is determined empirically. The maximum depth corresponds to a calibration position of the sample probe needle for use during operation by a user.

For example, in one embodiment of the invention a maximum depth may be determined by moving a sample probe needle over the cavity location in a fully raised position. The sample probe needle may then be moved down and may stop when it comes to rest near or at the bottom of the well. The sample probe needle is them moved back up and the distance it travels to reach the original fully raised position is determined. For example, a stepper motor may be used that counts the steps required to bring the sample probe needle back up to the original fully raised position. This number of steps in reverse will move the sample probe needle down to the location where the needle rests near or at the bottom of the well. The system records the operation (e.g., number of steps) that was required to move the sample probe needle from the bottom of the cavity to the fully raised position and may store the information in a computer-readable storage medium for later retrieval.

Process 400 continues by storing the calibration position in a computer-readable storage medium for later retrieval during a calibration operation by a user (operation 402). Each microplate type of the multiple different microplates can then be mapped by name to each cavity of the multiple cavities in the calibration fixture (operation 403). The mapping can then also be stored in the computer-readable storage medium for later use during a calibration operation by a user (operation 404). The computer-readable storage medium and the calibration fixture can then be provided to customers for use in a measurement instrument system adapted to use a sample probe needle to test various reagents in one or more of the multiple different microplates. The procedure used by customers is discussed below with respect to FIG. 4B.

For example, the calibration information may be stored in a table. Below is an exemplary table that may be used in embodiments of the invention.

| | Cavity in | Movement |
|---|---|---|
| | Calibration | Measured |
| Plate Identifier | Fixture | During Calibration |
| Flat Bottom Plate | 320 | X steps |
| PCR Plate | 321 | Y steps |
| Filter Plate | 322 | Z steps |
| Auxiliary Flat Plate | 323 | W steps |

FIG. 4B depicts an example flow chart of a process of calibrating a sample probe needle height using a calibration fixture according to one embodiment. Process 400B includes the use of a calibration fixture adapted for use with a measurement instrument having a sample probe needle. The calibration fixture includes multiple cavities each associated with one of multiple different microplates. Each cavity of the fixture has a cavity height dimension corresponding to a known depth of a set of wells within one of the multiple different microplates. The cavity height dimension is different among the multiple cavities.

In the illustrated embodiment, process 400B begins by receiving, at a user input of the measurement instrument, a selection of a microplate name assigned to a particular microplate of the multiple different microplates to be calibrated (operation 406). Process 400 continues by mapping the selected microplate name to the maximum depth the sample probe needle can travel into the set of wells for the particular microplate (operation 407) and assigning the sample probe needle height based on the maximum depth the sample probe needle can travel into the set of wells for the particular microplate (operation 408). Process 400B continues by repeating calibrating the sample probe needle height for each of the other of the multiple different microplates. In one embodiment, the sample probe needle height is calibrated for all of the multiple different microplates at once in a single operation. This completes process 400B according to one illustrative embodiment.

It should be appreciated that the specific operations illustrated in FIG. 4 provide a particular method of calibrating probe height according to one embodiment. Other sequences of operations may also be performed according to alternative embodiments. For example, alternative embodiments may perform the operations described above in a different order. Furthermore, additional operations may be added or removed depending on the particular applications. Moreover, each of the individual operations may include multiple sub-operations that may be performed in various sequences as appropriate.

In one embodiment, the cavity height dimension is determined empirically in advance for each of the multiple cavities in the calibration fixture based on the maximum depth of each of the corresponding sets of wells disposed within the multiple different microplates. The cavity height dimension can be assigned for each of the multiple cavities in the calibration fixture and stored in a computer-readable storage medium for use during the calibrating of the sample probe needle height. The maximum depth the sample probe needle can travel into each set of wells can be determined such that the sample probe needle comes to rest near the bottom of reservoirs of each of the sets of wells during operation to enable the reagents to be aspirated until the reservoir is almost empty and such that the sample probe needle and the microplates will not be damaged during operation. Each calibration fixture includes multiple cavities, each corresponding to one of the multiple different microplates. The techniques described herein allow for the probe height for all microplate types to be calibrated at once in a single operation instead of separately as in conventional systems.

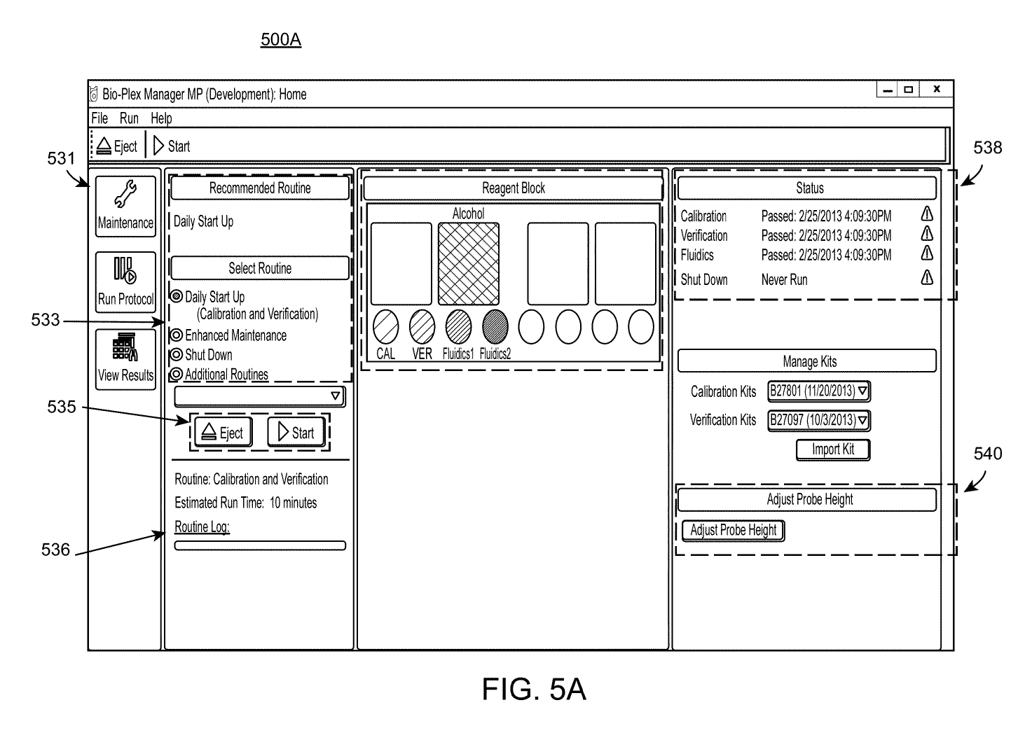

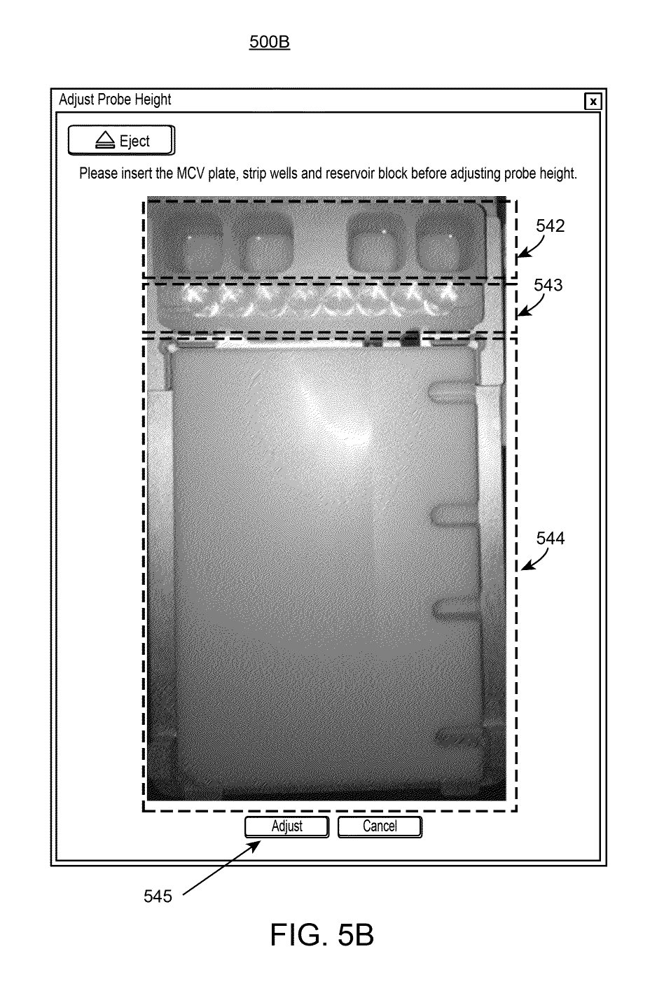

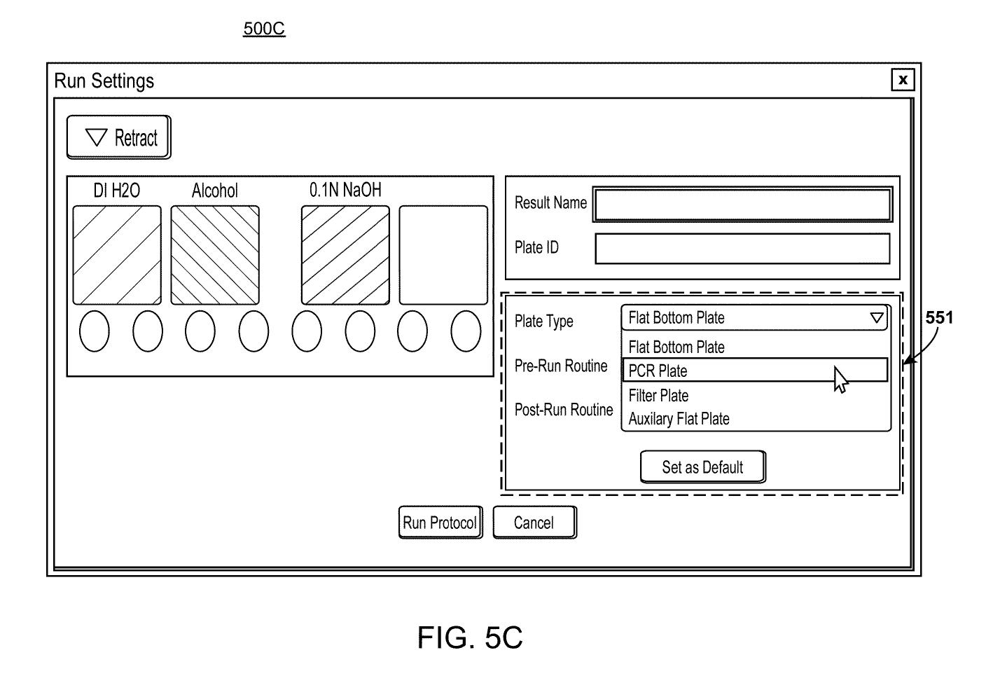

FIG. 5A depicts an example screen shot of a user interface used in a process for calibrating a probe height according to one embodiment. In the illustrated embodiment, user interface 500A is a maintenance view that users can navigate to in the system by actuating maintenance button 531. The maintenance view 500A includes controls 533 for selecting the operation to be performed by the system as well as controls 535 for starting the calibration process and ejecting the calibration fixture based upon selection by a user. View 500A further includes status indicators 538 and a routine log that can be selected using link 536. Finally, upon selection of button 540, the Adjust Probe Height dialog box of FIG. 5B is displayed.

FIG. 5B depicts an example screen shot of a user interface used in a process for calibrating a probe height according to one embodiment. The final graphic for the Adjust Probe Height dialog box can include a depiction of the probe height fixture 544 as illustrated in the figure. The graphic can further include a depiction of the associated strip wells 543 (e.g., with 8 wells) and reservoir block 542 (e.g., with 4 reservoirs). Strip wells may comprise a set of standard microplate wells (e.g., a standard 96-well microplate may have 12 strips of 8 wells). The wells may contain reagents to be dispensed in the assay and can have a different reagent in each well if desired. A reservoir block is a set of reservoirs that may contain fluids can be aspirated out of or dispensed into. These may be for reagents used in normal operation. The calibration procedure may not actually aspirate or dispense but will calibrate the probe or needle position near the bottom of the reservoirs or wells to enable fluid to be aspirated until the reservoir or well is almost empty. Customers can click on the adjust button 545 to begin the calibration operation.

FIG. 5C depicts an example screen shot of a user interface used in a process for calibrating a probe height according to one embodiment. The screen may instruct the user to insert the MCV plate (e.g., calibration fixture), strip wells and reservoir block. Each of the slots in the calibration fixture corresponds to a microplate type. When a user begins a calibration operation, the user can select a microplate type using controls 551 depicted in screen shot 500C. For example, a user may select a “PCR Plate.” Further, each of the microplate types corresponds to one of the slots in the probe height fixture. Each different plate may require a different probe height. Once the user enters the microplate type, the system knows which of the four probe heights to use.

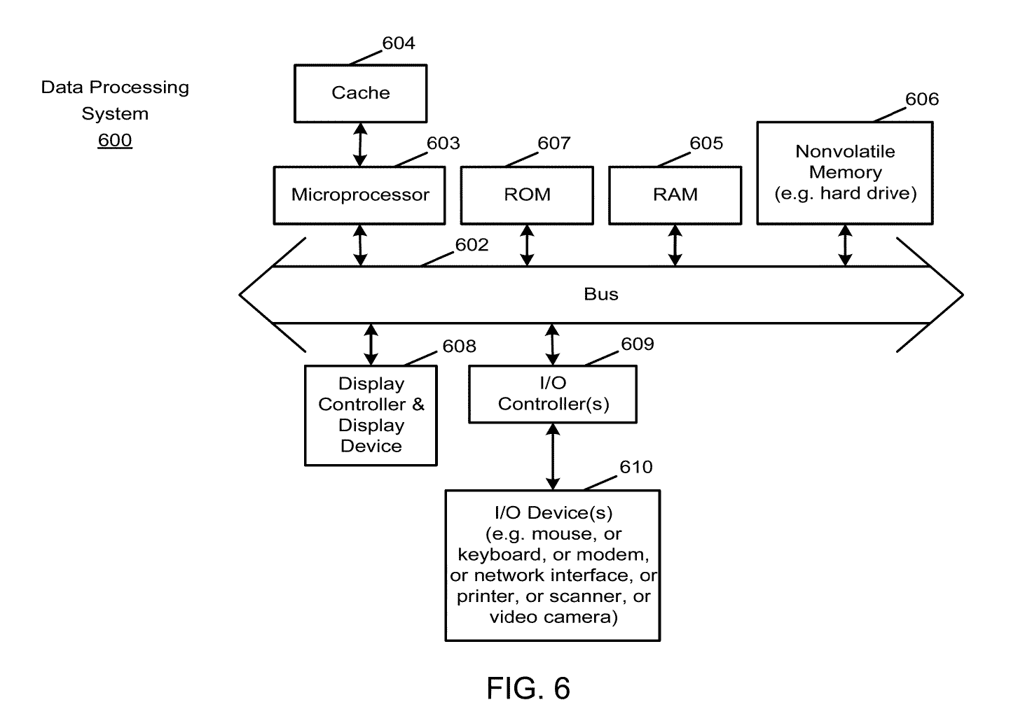

Provided below are descriptions of some devices (and components of those devices) that may be used in the systems and methods described above. These devices may be used, for instance, to receive, transmit, process, or store data related to any of the functionality described above. As will be appreciated by one of ordinary skill in the art, the devices described below may have only some of the components described below, or may have additional components. FIG. 6 depicts an example block diagram of a data processing system upon which the disclosed embodiments may be implemented. Embodiments may be practiced with various computer system configurations such as hand-held devices, microprocessor systems, microprocessor-based or programmable user electronics, minicomputers, mainframe computers, or similar systems. The embodiments can also be practiced in distributed computing environments where tasks are performed by remote processing devices that are linked through a wire-based or wireless network.

FIG. 6 shows one example of a data processing system, such as data processing system 600, which may be used with the described embodiments. Note that while FIG. 6 illustrates various components of a data processing system, it is not intended to represent any particular architecture or manner of interconnecting the components as such details are not germane to the techniques described herein. It will also be appreciated that network computers and other data processing systems which have fewer components or perhaps more components may also be used. The data processing system of FIG. 6 may, for example, a personal computer (PC), workstation, tablet, smartphone or other hand-held wireless device, or any device having similar functionality.

As shown, the data processing system 601 includes a system bus 602 which is coupled to a microprocessor 603, a Read-Only Memory (ROM) 607, a volatile Random Access Memory (RAM) 605, as well as other nonvolatile memory 606. In the illustrated embodiment, microprocessor 603 is coupled to cache memory 604. System bus 602 can be adapted to interconnect these various components together and also interconnect components 603, 607, 605, and 606 to a display controller and display device 608, and to peripheral devices such as input/output (“I/O”) devices 610. Types of I/O devices can include keyboards, modems, network interfaces, printers, scanners, video cameras, or other devices well known in the art. Typically, I/O devices 610 are coupled to the system bus 602 through I/O controllers 609. In one embodiment the I/O controller 609 includes a Universal Serial Bus (“USB”) adapter for controlling USB peripherals or other type of bus adapter.

RAM 605 can be implemented as dynamic RAM (“DRAM”) which requires power continually in order to refresh or maintain the data in the memory. The other nonvolatile memory 606 can be a magnetic hard drive, magnetic optical drive, optical drive, DVD RAM, or other type of memory system that maintains data after power is removed from the system. While FIG. 6 shows that nonvolatile memory 606 as a local device coupled with the rest of the components in the data processing system, it will be appreciated by skilled artisans that the described techniques may use a nonvolatile memory remote from the system, such as a network storage device coupled with the data processing system through a network interface such as a modem or Ethernet interface (not shown).

With these embodiments in mind, it will be apparent from this description that aspects of the described techniques may be embodied, at least in part, in software, hardware, firmware, or any combination thereof. It should also be understood that embodiments can employ various computer-implemented functions involving data stored in a data processing system. That is, the techniques may be carried out in a computer or other data processing system in response executing sequences of instructions stored in memory. In various embodiments, hardwired circuitry may be used independently, or in combination with software instructions, to implement these techniques. For instance, the described functionality may be performed by specific hardware components containing hardwired logic for performing operations, or by any combination of custom hardware components and programmed computer components. The techniques described herein are not limited to any specific combination of hardware circuitry and software.

Embodiments may also be in the form of computer code stored on a computer-readable medium. Computer-readable media can also be adapted to store computer instructions, which when executed by a computer or other data processing system, such as data processing system 600, are adapted to cause the system to perform operations according to the techniques described herein. Computer-readable media can include any mechanism that stores information in a form accessible by a data processing device such as a computer, network device, tablet, smartphone, or any device having similar functionality. Examples of computer-readable media include any type of tangible article of manufacture capable of storing information thereon such as a hard drive, floppy disk, DVD, CD-ROM, magnetic-optical disk, ROM, RAM, EPROM, EEPROM, flash memory and equivalents thereto, a magnetic or optical card, or any type of media suitable for storing electronic data. Computer-readable media can also be distributed over a network-coupled computer system, which can be stored or executed in a distributed fashion.

Throughout the foregoing description, for the purposes of explanation, numerous specific details were set forth in order to provide a thorough understanding of the invention. It will be apparent, however, to persons skilled in the art that these embodiments may be practiced without some of these specific details. Accordingly, the scope and spirit of the invention should be judged in terms of the claims which follow as well as the legal equivalents thereof.

What is claimed is:

1. A system comprising:
a measurement instrument that includes:
a sample probe needle;
a user input;
a processor; and
a computer-readable storage medium coupled with the processor and having instructions stored thereon which when executed by the processor are configured to determine a height of the sample probe needle; and
a calibration fixture adapted for use with the measurement instrument and having multiple cavities, each cavity associated with one of multiple different microplates and having a cavity height dimension corresponding to a known depth of a set of wells within the one of the multiple different microplates, wherein the cavity height dimension is different among the multiple cavities, and wherein the set of wells are adapted to contain various reagents for use in one or more assays, and
wherein the sample probe needle height is calibrated for all of the multiple different microplates at once in a single operation.

2. The system of claim 1 wherein the instructions in the computer-readable medium include:
(1) instructions to receive, at the user input, a selection of a microplate name assigned to a first microplate of the multiple different microplates to be calibrated;
(2) instructions to map the microplate name to a maximum depth the sample probe needle can travel into the set of wells for the first microplate; and
(3) instructions to set the sample probe needle height based on the maximum depth the sample probe needle can travel into the set of wells for the first microplate; and
(4) instructions to repeat calibration for the sample probe needle height for each of the other of the multiple different microplates.

3. The system of claim 1 wherein the cavity height dimension is determined empirically in advance for each of the multiple cavities in the calibration fixture based on the maximum depth of each of the corresponding sets of wells disposed within the multiple different microplates.

4. The system of claim 1 wherein the cavity height dimension is assigned for each of the multiple cavities in the calibration fixture and stored in the computer-readable storage medium.

5. The system of claim 1 wherein the maximum depth the sample probe needle can travel into each set of wells is determined such that the sample probe needle comes to rest near the bottom of reservoirs of each of the sets of wells during operation to enable the reagents to be aspirated until the reservoir is almost empty.

6. The system of claim 1 wherein the maximum depth the sample probe needle can travel into each set of wells is determined such that the sample probe needle and the microplates will not be damaged during operation.

7. A method of using a calibration fixture adapted for use with a measurement instrument, the calibration fixture having multiple cavities, each cavity associated with one of multiple different microplates and having a cavity height dimension corresponding to a known depth of a set of wells within one of the multiple different microplates, wherein the cavity height dimension is different among the multiple cavities, and wherein the set of wells are adapted to contain various reagents for use in one or more assays, the method comprising:
calibrating a sample probe needle height for the measurement instrument, the calibrating comprising:
(1) receiving, at a user input of the measurement instrument, a selection of a microplate name assigned to a first microplate of the multiple different microplates to be calibrated;
(2) mapping the microplate name to a maximum depth the sample probe needle can travel into the set of wells for the first microplate;
(3) assigning the sample probe needle height based on the maximum depth the sample probe needle can travel into the set of wells for the first microplate; and
(4) repeating calibrating the sample probe needle height for each of the other of the multiple different microplates.

8. The method of claim 7 wherein the sample probe needle height is calibrated for all of the multiple different microplates at once in a single operation.

9. The method of claim 7 wherein the cavity height dimension is determined empirically in advance for each of the multiple cavities in the calibration fixture based on the maximum depth of each of the corresponding sets of wells disposed within the multiple different microplates.

10. The method of claim 7 wherein the cavity height dimension is assigned for each of the multiple cavities in the calibration fixture and stored in a computer-readable storage medium for use during the calibrating of the sample probe needle height.

11. The method of claim 7 wherein the maximum depth the sample probe needle can travel into each set of wells is determined such that the sample probe needle comes to rest near the bottom of reservoirs of each of the sets of wells during operation to enable the reagents to be aspirated until the reservoir is almost empty.

12. The method of claim 7 wherein the maximum depth the sample probe needle can travel into each set of wells is determined such that the sample probe needle and the microplates will not be damaged during operation.

13. An article of manufacture comprising a computer-readable storage medium having instructions stored thereon which when executed by a computer are configured to calibrate a sample probe needle height using a calibration fixture adapted for use with a measurement instrument, the calibration fixture having multiple cavities, each cavity associated with one of multiple different microplates and having a cavity height dimension corresponding to a known depth of a set of wells within one of the multiple different microplates, wherein the cavity height dimension is different among the multiple cavities, and wherein the set of wells are adapted to contain various reagents for use in one or more assays, the instructions comprising:
(1) instructions to receive, at a user input of the measurement instrument, a selection of a microplate name assigned to a first microplate of the multiple different microplates to be calibrated;
(2) instruction to map the microplate name to a maximum depth the sample probe needle can travel into the set of wells for the first microplate;
(3) instructions to assign the sample probe needle height based on the maximum depth the sample probe can travel into the set of wells for the first microplate; and
(4) instructions to repeat calibration of the sample probe needle height for each of the other of the multiple different microplates.

14. The article of manufacture of claim 13 wherein the sample probe needle height is calibrated for all of the multiple different microplates at once in a single operation.

15. The article of manufacture of claim 13 wherein the cavity height dimension is determined empirically in advance for each of the multiple cavities in the calibration fixture based on the maximum depth of each of the corresponding sets of wells disposed within the multiple different microplates.

16. The article of manufacture of claim 13 wherein the cavity height dimension is assigned for each of the multiple cavities in the calibration fixture and stored in a computer-readable storage medium for use during the calibrating of the sample probe needle height.

17. The article of manufacture of claim 13 wherein the maximum depth the sample probe needle can travel into each set of wells is determined such that the sample probe needle comes to rest near the bottom of reservoirs of each of the sets of wells during operation to enable the reagents to be aspirated until the reservoir is almost empty.

18. The article of manufacture of claim 13 wherein the maximum depth the sample probe needle can travel into each set of wells is determined such that the sample probe needle and the microplates will not be damaged during operation.

19. An calibration fixture formed in the shape of a microplate and adapted for use with the measurement instrument, the calibration fixture comprising:
a base; and
multiple cavities disposed within the base, each cavity associated with one of multiple different microplates and having a cavity height dimension corresponding to a known depth of a set of wells within one of the multiple different microplates, wherein each cavity is assigned to one of the multiple different microplates and the cavity height dimension is different among the multiple cavities, and wherein the set of wells are adapted to contain various reagents for use in one or more assays.

20. The calibration fixture of claim 19 wherein a maximum depth a sample probe needle of the measurement instrument can travel into the set of wells of the microplates is determined empirically in advance for each of the multiple different microplates.

21. The calibration fixture of claim 20 wherein a sample probe needle height is determined based on the maximum depth and is stored in a computer-readable storage medium for later retrieval during a calibration operation by a user.

22. The calibration fixture of claim 19 wherein each microplate type of the multiple different microplates is mapped by name to the cavity assigned to the microplate.

23. The calibration fixture of claim 22 wherein the mapping is stored in the computer-readable storage medium for later retrieval during a calibration operation by a user.

24. An method comprising:
forming a calibration fixture in the shape of a microplate, wherein the calibration fixture comprises multiple cavities each associated with one of multiple different microplates and having a cavity height dimension corresponding to a known depth of a set of wells within one of the multiple different microplates, wherein each cavity is assigned to one of the multiple different microplates and the cavity height dimension is different among the multiple cavities, and wherein the set of wells are adapted to contain various reagents for use in one or more assays; and
empirically determining a maximum depth a sample probe needle of a measurement instrument can travel into the set of wells of the microplates for each of the multiple different microplates;
determining a sample probe needle height based on the maximum depth; and
storing the sample probe needle height in a computer-readable storage medium for later retrieval during a calibration operation by a user.

25. The method of claim 24 further comprising mapping each microplate type of the multiple different microplates by name to the cavity assigned to the microplate.

26. The method of claim 25 further comprising storing the mapping in the computer-readable storage medium for later retrieval during a calibration operation by a user.
